(19) United States
(12) Patent Application Publication
(10) Pub. No.: US 2017/0153830 A1
(43) Pub. Date: Jun. 1, 2017

(54) DATA RECOVERY DEVICE, DATA STORAGE DEVICE AND CONTROL METHOD THEREOF

(71) Applicant: APACER TECHNOLOGY INC., New Taipei City (TW)

(72) Inventors: Jiunn-Chang Lee, New Taipei City (TW); Jia-Wei Lin, New Taipei City (TW)

(21) Appl. No.: 14/965,483

(22) Filed: Dec. 10, 2015

(30) Foreign Application Priority Data
Nov. 27, 2015 (TW) 104139550

(51) Int. Cl. G06F 3/06

(52) U.S. Cl. CPC G06F 3/0619; G06F 3/065; G06F 3/0685

(57) ABSTRACT

A data storage device includes a volatile first storage unit, a non-volatile second storage unit and a control unit. The first storage unit is used for temporarily storing at least one data. The second storage unit includes plural backup spaces. A size of each backup space is larger than or equal to a size of the first storage unit. The control unit is electrically connected with the first storage unit and the second storage unit. The control unit accesses the at least one data according to a control command, and the control unit periodically writes the at least one data to one of the plural backup spaces.

### FIELD OF THE INVENTION

The present invention relates to a data recovery device, a data storage device and a control method, and more particularly to a data recovery device and a data storage device having a volatile memory and a control method thereof.

### BACKGROUND OF THE INVENTION

Recently, a big data leads to more confident decision making, and a better decision achieves greater operational efficiency. The big data indicates a massive amount of data that are difficult to be analyzed and processed by a single computer within a reasonable time period. Consequently, the big data is usually stored in a computer host or a workstation that can quickly process data.

For quickly processing data, the storage device having quick accessing capability is essential. A solid state drive (SSD) is a storage device using non-volatile NAND memories as permanent memories. Generally, the data accessing speed of the non-volatile memory is several times the data accessing speed of the conventional hard disc. However, if the data amount is very huge, the accessing time period of the solid state drive is still too long to meet the user's requirements.

Unlike the non-volatile memory, the data stored in the volatile memory is not retained in the volatile memory when no power is supplied to the volatile memory. For example, the volatile memory includes a dynamic random access memory (DRAM) or a static random access memory (SRAM). The data accessing speed of the volatile memory is faster than the data accessing speed of the non-volatile memory. However, since the data of the volatile memory is lost when no power is supplied to the volatile memory, the volatile memory is not used as the general storage device.

### SUMMARY OF THE INVENTION

An object of the present invention provides a data recovery device, a data storage device and a control method in order to overcome the drawbacks encountered by the prior arts.

In accordance with an aspect of the present invention, there is provided a data storage device. The data storage device includes a volatile first storage unit, a non-volatile second storage unit and a control unit. The first storage unit is used for temporarily storing at least one data. The second storage unit includes plural backup spaces. A size of each backup space is larger than or equal to a size of the first storage unit. The control unit is electrically connected with the first storage unit and the second storage unit. The control unit accesses the at least one data according to a control command, and the control unit periodically writes the at least one data to one of the plural backup spaces.

In an embodiment, the first storage unit is a random access memory (RAM).

In an embodiment, the second storage unit is a flash memory or a disk of a hard drive.

In an embodiment, the at least one data of the first storage unit is automatically backed up to one of the plural backup spaces by the control unit before the control unit is in a power-off state.

In an embodiment, the data storage device further includes a timer unit for providing time information. The control unit comprises a firmware, and the firmware of the control unit writes the at least one data into one of the plural backup spaces according to the time information.

In accordance with another aspect of the present invention, there is provided a data recovery device. The data recovery device includes a volatile first storage unit, a non-volatile second storage unit and a control unit. The first storage unit is used for temporarily storing at least one data. The second storage unit includes plural backup spaces. Each of the plural backup spaces contains a backup of the at least one data which is stored at a corresponding time point. The control unit is electrically connected with the first storage unit and the second storage unit. The control unit recovers the at least one data from one of the plural backup spaces to the first storage unit according to a recovery command.

In an embodiment, the first storage unit is a random access memory (RAM).

In an embodiment, the second storage unit is a flash memory or a disk of a hard drive.

In an embodiment, the control unit automatically recovers the at least one data from one of the plural backup spaces to the first storage unit after the control unit is powered on.

In an embodiment, the control unit comprises a firmware, and the recovery command contains a designated recovery time point. The firmware selects the backup of the at least one data and recovers the backup of the at least one data to the first storage unit according to the designated recovery time point.

In an embodiment, the backup of the at least one data is an image file.

In accordance with a further aspect of the present invention, there is provided a control method for a data recovery device. The data recovery device includes a volatile first storage unit, a non-volatile second storage unit and a control unit. The second storage unit includes plural backup spaces. The control method includes the following steps. Firstly, at least one data is temporarily stored into the first storage unit. Then, the control unit accesses the at least one data. Then, the control unit recovers the at least one data from one of the plural backup spaces to the first storage unit according to a recovery command, or periodically backs up the at least one data to one of the plural backup spaces.

In an embodiment, the first storage unit is a random access memory (RAM).

In an embodiment, the second storage unit is a flash memory or a disk of a hard drive.

In an embodiment, the control method further includes a step of automatically backing up the at least one data to one of the plural backup spaces before the control unit is in a power-off state.

In an embodiment, the control method further includes a step of automatically recovering the at least one data from one of the plural backup spaces to the first storage unit after the control unit is powered on.

From the above descriptions, the present invention provides a data storage device and a data recovery device. The volatile first storage unit is used as the main storage unit, and the non-volatile second storage unit is used as the backup device. The present invention further provides a control method for preventing from data loss after the control unit is in a power-off state. Since the main data device is the high-speed volatile memory, the data accessing speed is largely enhanced. Moreover, the non-volatile memory is used to back up the data of the volatile memory at different time points. Consequently, in case that the data is erroneously deleted or the data is burnt out, the user can select a proper backup to recover the data.

The above contents of the present invention will become more readily apparent to those ordinarily skilled in the art after reviewing the following detailed description and accompanying drawings, in which:

### BRIEF DESCRIPTION OF THE DRAWINGS

FIG. 1 is a schematic functional block diagram illustrating a data storage device according to an embodiment of the present invention;

FIG. 2 schematically illustrates the operation of the data storage device according to the embodiment of the present invention;

FIG. 3 is a schematic functional block diagram illustrating a data recovery device according to an embodiment of the present invention;

FIG. 4 schematically illustrates the operation of the recovery storage device according to the embodiment of the present invention; and

FIG. 5 is a flowchart illustrating a control method of a data recovery device according to an embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. In the following embodiments and drawings, the elements irrelevant to the concepts of the present invention are omitted and not shown. For well understanding the present invention, the elements shown in the drawings are not in scale with the elements of the practical product.

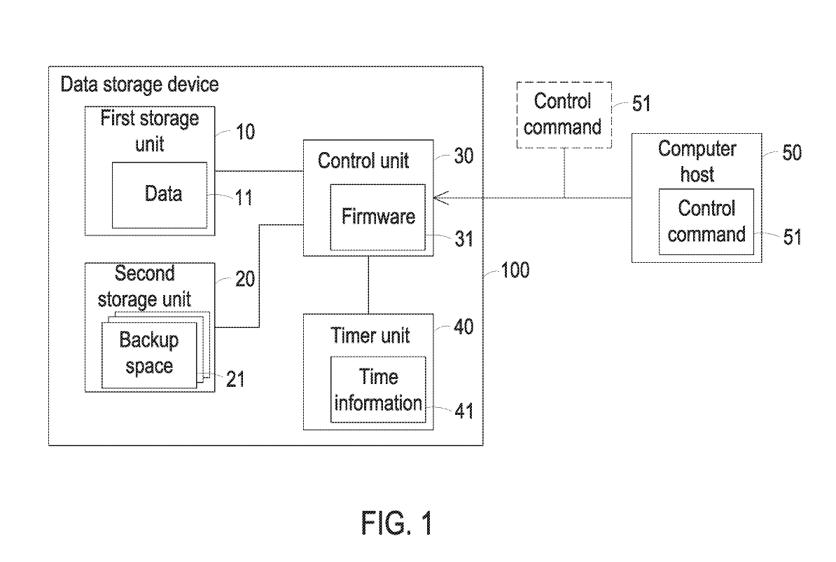

FIG. 1 is a schematic functional block diagram illustrating a data storage device according to an embodiment of the present invention. As shown in FIG. 1, the data storage device 100 comprises a volatile first storage unit 10, a non-volatile second storage unit 20 and a control unit 30. For example, the first storage unit 10 is a random access memory (RAM) such as a dynamic random access memory (DRAM) or a static random access memory (SRAM). The second storage unit 20 is a flash memory or a disk of a hard drive. The control unit 30 is a controller or a processor with storing and computing functions. The control unit 30 is electrically connected with the first storage unit 10 and the second storage unit 20.

The first storage unit 10 is used for temporarily storing at least one data 11. The second storage unit 20 comprises plural backup spaces 21. The sizes of the backup spaces 21 are identical or different. The size of the backup space 21 is larger than or equal to the size of the first storage unit 10. The at least one data 11 includes an application program and/or a file of an operation system.

Moreover, the data storage device 100 is electrically connected with a computer host 50. The computer host 50 issues a control command 51 to the control unit 30. According to the control command 51, a firmware 31 of the control unit 30 accesses one of the plural data 11. In this context, the accessing operation comprises a reading operation, a writing operation, and/or any other appropriate I/O operation. Moreover, the connection between the computer host 50 and the data storage device 100 is established through a SATA interface.

It is noted that before the control unit 30 is in a power-off state, the plural data 11 of the first storage unit 10 are automatically backed up to one of the plural backup spaces 21 by the control unit 30. Moreover, the control unit 30 can periodically write the plural data 11 into one of the plural backup spaces 21.

Moreover, the data storage device 100 comprises a timer unit 40. The timer unit 40 is electrically connected with the control unit 30. The timer unit 40 provides time information 41 to the firmware 31. According to the time information 41, the firmware 31 writes the plural data 11 into one of the plural backup spaces 21. That is, the writing operation is triggered according to the time information 41. An example of the time information 41 includes but is not limited to an hour, a day or a week.

In this embodiment, the control unit 30 only performs the I/O operation on the data of the first storage unit 10. Moreover, before the control unit 30 is in a power-off state, the plural data 11 of the first storage unit 10 are automatically or periodically backed up to one of the plural backup spaces 21 by the control unit 30. In other words, the first storage unit 10 with high accessing performance is used as the main storage unit.

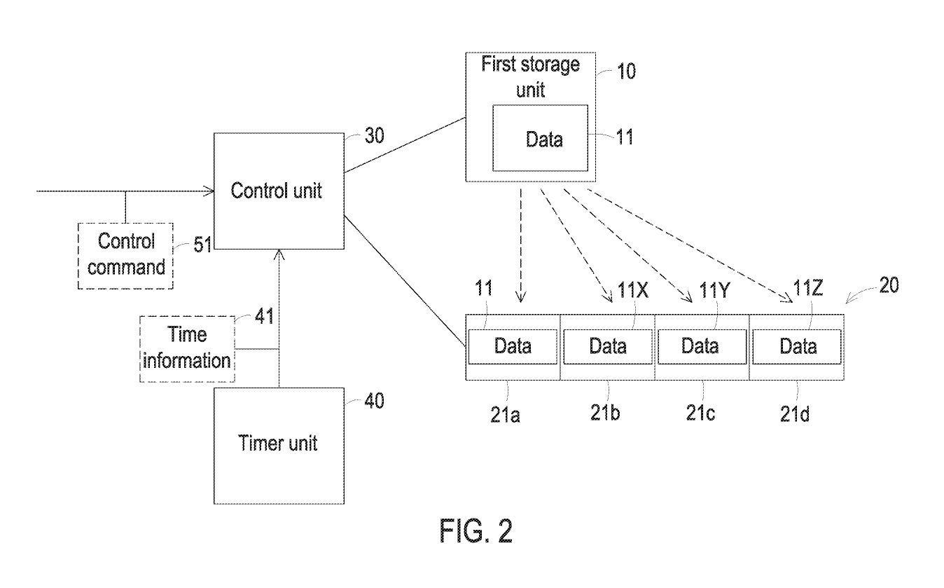

FIG. 2 schematically illustrates the operation of the data storage device according to the embodiment of the present invention. Please refer to FIGS. 1 and 2. The data storage device 100 is electrically connected with the computer host 50. A power supply device (not shown) of the computer host 50 provides electricity to the data storage device 100. In this embodiment, the data storage device 100 is a solid state drive, the first storage unit 10 is a dynamic random access memory (DRAM), the second storage unit 20 is a NAND flash memory, and the control unit 30 is a controller.

The second storage unit 20 comprises four backup spaces 21a, 21b, 21c and 21d. The size of each backup space is larger than or equal to the size of the first storage unit 10. For example, the size of the first storage unit 10 is 10 GB, and the size of the second storage unit 20 is 40 GB. Under this circumstance, the second storage unit 20 has at most four backup spaces for storing a backup of the data 11 from the first storage unit 10.

Before the control unit 30 is in a power-off state, the control unit 30 writes or moves the data 11 to the backup space 21a, and periodically backs up the data 11 to the backup spaces 21b, 21c and 21d in a sequential manner. For example, the data 11 is backed up to the backup space 21b, 21c or 21d once a week. Consequently, the newest data 11 can be synchronously stored in the second storage unit 20, and the data 11 stored at different time points can be contained in the second storage unit 20.

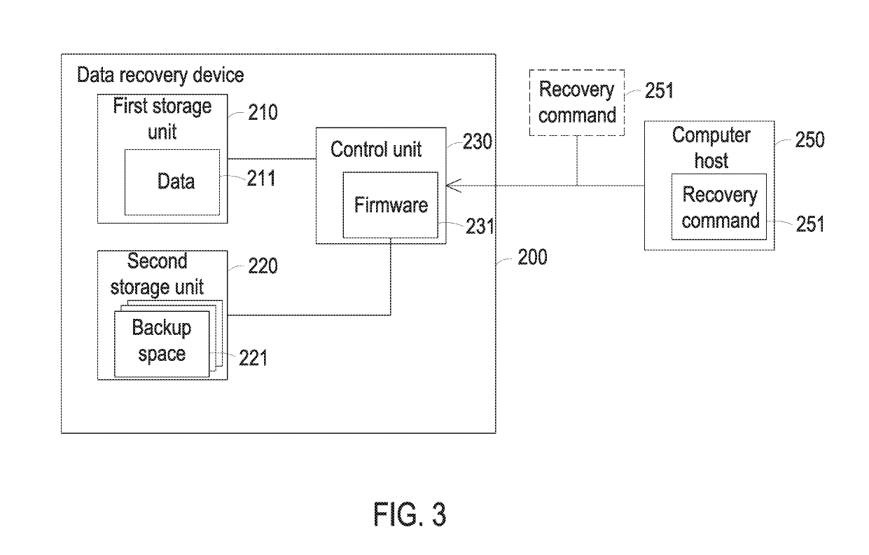

FIG. 3 is a schematic functional block diagram illustrating a data recovery device according to an embodiment of the present invention. As shown in FIG. 3, the data recovery device 200 comprises a volatile first storage unit 210, a non-volatile second storage unit 220 and a control unit 230. The examples of the first storage unit 210, the second storage unit 220 and the control unit 230 of this embodiment are similar to the examples of the first storage unit 10, the second storage unit 20 and the control unit 30 of the first embodiment, and are not redundantly described herein.

The first storage unit 210 is used for temporarily storing at least one data 211. The second storage unit 220 comprises plural backup spaces 221. The data 211 stored at different time points are contained in the backup spaces 221 of the second storage unit 220.

It is noted that since the first storage unit 210 has volatility, no data is stored in the first storage unit 210 at the time when the first storage unit 210 is powered on. Consequently, after the control unit 230 is powered on, the data 211 stored in one of the plural backup spaces 221 is moved to the first storage unit 210 by the control unit 230. Preferably, the newly updated data 211 is recovered to the first storage unit 210. The data 211 includes an application program and/or a file of an operation system.

In addition, the data 211 stored in another of the plural backup spaces 221 are moved to the first storage unit 210 by the control unit 230 according to a recovery command 251 from a computer host 250. The recovery command 251 contains a designated recovery time point. According to the designated recovery time point, a firmware 231 of the control unit 230 selects the backup of the data 211 and recovers the backup of the data 211 to the first storage unit 210. In an embodiment, the backup of the data 211 is an image file.

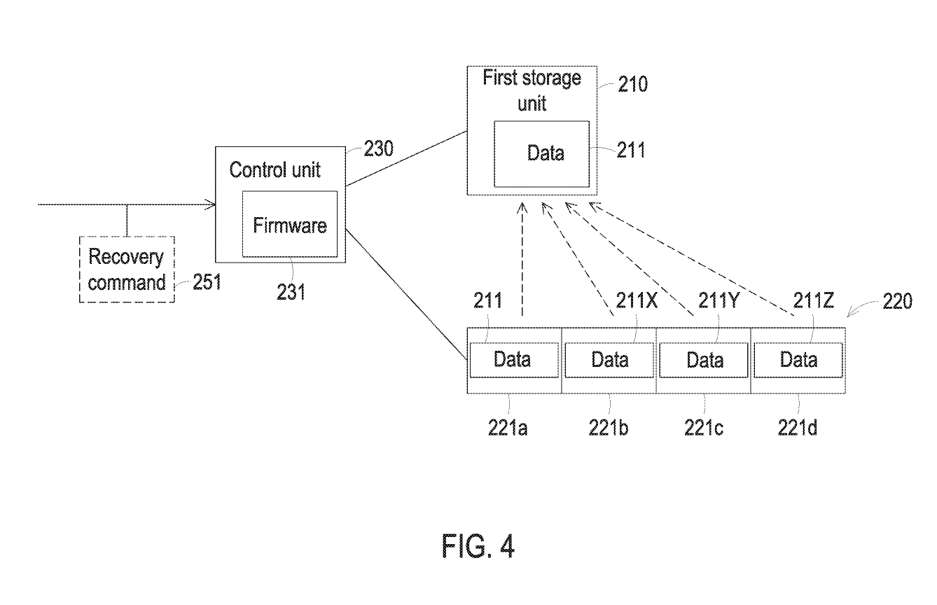

FIG. 4 schematically illustrates the operation of the recovery storage device according to the embodiment of the present invention. Please refer to FIGS. 3 and 4. The data recovery device 200 is electrically connected with the computer host 250. A power supply device (not shown) of the computer host 250 provides electricity to the data recovery device 200. In this embodiment, the data recovery device 200 is a solid state drive, the first storage unit 210 is a dynamic random access memory (DRAM), the second storage unit 220 is a NAND flash memory, and the control unit 230 is a controller.

The second storage unit 220 comprises four backup spaces 221a, 221b, 221c and 221d. The newest backup of data 211 is stored in the backup space 221a. For example, the data 211 is an operation system. The backups of the data 211 stored at other time times (i.e., the data 211X, 211Y and 211Z) are stored in the backup spaces 221b, 221c and 221d, respectively.

After the computer host 250 is powered on, the data 211 in the backup space 221a is automatically moved to the first storage unit 210 by the firmware 231 of the control unit 230. Consequently, the user can operate the operation system in the first storage unit 210 at a high speed and recovers the data 211X, 211Y and 211Z which are stored in the backup spaces 221b, 221c and 221d at different time points.

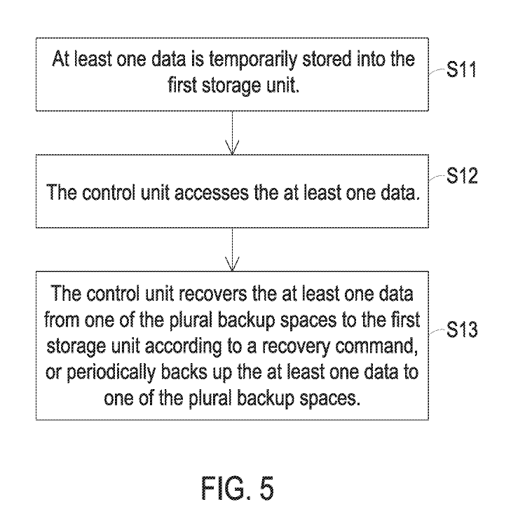

FIG. 5 is a flowchart illustrating a control method of a data recovery device according to an embodiment of the present invention. The data recovery device comprises a volatile first storage unit, a non-volatile second storage unit and a control unit. The second storage unit comprises plural backup spaces. The control method comprises the following steps.

In a step S11, at least one data is temporarily stored into the first storage unit.

In a step S12, the control unit accesses the at least one data.

In a step S13, the control unit recovers the at least one data from one of the plural backup spaces to the first storage unit according to a recovery command, or periodically backs up the at least one data to one of the plural backup spaces.

In an embodiment, the first storage unit is a random access memory (RAM), the second storage unit is a flash memory or a disk of a hard drive, and the control unit is a controller.

The control method further comprises a step of automatically backing up the at least one data to one of the plural backup spaces by the control unit before the control unit is in a power-off state. The content of this step has been mentioned above, and is not redundantly described herein.

The control method further comprises a step of automatically recovering the at least one data from one of the plural backup spaces to the first storage unit after the control unit is powered on. The content of this step has been mentioned above, and is not redundantly described herein.

From the above descriptions, the present invention provides a data storage device and a data recovery device. The volatile first storage unit is used as the main storage unit, and the non-volatile second storage unit is used as the backup device. The present invention further provides a control method for preventing from data loss after the control unit is in a power-off state. Since the main data device is the high-speed volatile memory, the data accessing speed is largely enhanced. Moreover, the non-volatile memory is used to back up the data of the volatile memory at different time points. Consequently, in case that the data is erroneously deleted or the data is burnt out, the user can select a proper backup to recover the data.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A data storage device, comprising:
a volatile first storage unit for temporarily storing at least one data;
a non-volatile second storage unit comprising plural backup spaces, wherein a size of each backup space is larger than or equal to a size of the first storage unit; and
a control unit electrically connected with the first storage unit and the second storage unit, wherein the control unit accesses the at least one data according to a control command, and the control unit periodically writes the at least one data to one of the plural backup spaces.

2. The data storage device according to claim 1, wherein the first storage unit is a random access memory (RAM).

3. The data storage device according to claim 1, wherein the second storage unit is a flash memory or a disk of a hard drive.

4. The data storage device according to claim 1, wherein the at least one data of the first storage unit is automatically backed up to one of the plural backup spaces by the control unit before the control unit is in a power-off state.

5. The data storage device according to claim 1, further comprising a timer unit for providing time information, wherein a firmware of the control unit writes the at least one data into one of the plural backup spaces according to the time information.

6. A data recovery device, comprising:
a volatile first storage unit for temporarily storing at least one data;
a non-volatile second storage unit comprising plural backup spaces, wherein each of the plural backup spaces contains a backup of the at least one data which is stored at a corresponding time point; and
a control unit electrically connected with the first storage unit and the second storage unit, wherein the control unit recovers the at least one data from one of the plural backup spaces to the first storage unit according to a recovery command.

7. The data recovery device according to claim 6, wherein the first storage unit is a random access memory (RAM).

8. The data recovery device according to claim 6, wherein the second storage unit is a flash memory or a disk of a hard drive.

9. The data recovery device according to claim 6, wherein after the control unit is powered on, the control unit automatically recovers the at least one data from one of the plural backup spaces to the first storage unit.

10. The data recovery device according to claim 6, wherein the control unit comprises a firmware, and the recovery command contains a designated recovery time point, wherein the firmware selects the backup of the at least one data and recovers the backup of the at least one data to the first storage unit according to the designated recovery time point.

11. The data recovery device according to claim 10, wherein the backup of the at least one data is an image file.

12. A control method for a data recovery device, the data recovery device comprising a volatile first storage unit, a non-volatile second storage unit and a control unit, the second storage unit comprising plural backup spaces, the control method comprising steps of:
temporarily storing at least one data into the first storage unit;
the control unit accessing the at least one data; and
the control unit recovering the at least one data from one of the plural backup spaces to the first storage unit according to a recovery command, or periodically backing up the at least one data to one of the plural backup spaces.

13. The control method according to claim 12, wherein the first storage unit is a random access memory (RAM).

14. The control method according to claim 12, wherein the second storage unit is a flash memory or a disk of a hard drive.

15. The control method according to claim 12, further comprising a step of automatically backing up the at least one data to one of the plural backup spaces before the control unit is in a power-off state.

16. The control method according to claim 12, further comprising a step of automatically recovering the at least one data from one of the plural backup spaces to the first storage unit after the control unit is powered on.
